(19) United States
(12) Patent Application Publication
(10) Pub. No.: US 2014/0201292 A1
(43) Pub. Date: Jul. 17, 2014

(54) DIGITAL BUSINESS CARD SYSTEM PERFORMING SOCIAL NETWORKING COMMONALITY COMPARISIONS, PROFESSIONAL PROFILE CURATION AND PERSONAL BRAND MANAGEMENT

(71) Applicant: ICON.ME, LLC, Austin, TX (US)

(72) Inventors: Kent Savage, Austin, TX (US); Matt Hovis, Austin, TX (US); Meetesh Karia, Austin, TX (US)

(73) Assignee: Icon.me, LLC, Austin, TX (US)

(21) Appl. No.: 13/744,249

(22) Filed: Jan. 17, 2013

(51) Int. Cl. H04L 12/58

(52) U.S. Cl. CPC H04L 51/32
USPC 709/206

(57) ABSTRACT

An icon added to a message of a sender provides a tool for recipients of the message to determine commonalities with the sender. The recipient activates the icon to initiate retrieval of social networking information from social networking network locations of the recipient to the recipient's computer. The recipient's social networking information is then forwarded to a commonality engine that compares the recipient's social networking information with social networking information of the sender to provide the recipient with commonalities between the recipient and the sender.

### BACKGROUND OF THE INVENTION

1. Field of the Invention

The present invention relates in general to the field of online social networking and personal brand management, and more particularly to commonality comparison, professional profile curation and personal analytics through electronic communications.

2. Description of the Related Art

Social networking has impacted lives from both a personal and professional perspective. Facebook is one example of a social networking website that has found acceptance for both businesses and individuals to communicate with interested members. Individuals who have Facebook pages provide access to personal information posted on their pages for “friends,” such as relatives or other individuals with whom a personal relationship exists. Businesses often have Facebook pages as a way to reach out to customers and potential customers. In addition, businesses will often pay to advertise on individual Facebook pages.

Another example of a social networking website is LinkedIn, which caters to a more professional crowd compared to Facebook. Facebook tends to provide a resource for sharing personal information between individuals who have an existing relationship, while LinkedIn attempts to extend an individual's professional relationship by providing an extension to the professional relationships of those with whom the individual has established a LinkedIn relationship. LinkedIn allows members to post basic information much like a resume on a publicly accessible web page while keeping more detailed information accessible to those with whom the individual has established a relationship.

Facebook and Linked-in base communications between members on existing relationships and provide an interface to allow sharing of member information. An example of a social networking website that takes a somewhat different approach is Twitter. Twitter allows a member to issue tweets having relatively few characters. The tweets broadcast to all members who follow the tweeter to allow rapid dissemination of a message that has only a brief content. Tweets can include references to other resources, such as a universal resource locator (URL) leading to a network address, so that a tweet is effectively supplemented by other information.

One problem that has arisen with social networking is that too much information has become available. End users who want to review the likes and interests of potential personal and professional relationships have a wide variety of resources to check, many of which have limited access. Even if an end user can locate and review social networking resources, the confusing array of personal and professional information can lead to dubious conclusions about others.

### SUMMARY OF THE INVENTION

Therefore a need has arisen for a system and method that manages an individual's professional brand through digital communication with the purpose of sharing one's contact information and social content while analyzing what one has in common with others and a suite of analytics to measure one's personal reach and brand strength.

In accordance with the present invention, a system and method are provided which substantially reduce the disadvantages and problems associated with previous methods and systems for presenting one's true professional persona, analyzing social networking resources and measuring one's personal and/or professional brand. Social networking information gathered for end users is analyzed to aggregate, curate and present relevant content about a user and to identify commonalities between end users. A personal icon representation associated with an end user provides analysis, aggregation, curation, sharing and presentation of the user's relevant content and commonalities with other users. The personal icon representation allows end users to present and share contact information, professional content and interests, and to uncover commonalities with others for the purpose of making an initial contact, establishing a relationship, and/or maintaining ongoing relationships. For instance, a personal icon included with messages between the end users activates from the message to allow a message recipient to perform a commonality analysis between the recipient and the message sender.

More specifically, a commonality server stores social networking information gathered when account holders share their icon electronically through the web, email or sms. A recipient of the communication activates the icon to initiate a commonality comparison with the sender of the message. The recipient's computer system retrieves and downloads social networking information of the recipient to the commonality server so that a commonality engine can perform a commonality comparison between the social networking information of the recipient and the sender. Commonalities between the recipient and sender are then reported to the recipient, such as common interests in food, technology, politics, sports, recreational activities, charities, connections, etc. . . .

The present invention provides a number of important technical advantages. One example of an important technical advantage is that potentially vast amounts of social networking information are automatically gathered and managed for the presentation and sharing of relevant content and commonalities between senders and recipients. Commonalities provide a basis for making a good impression and establishing a lasting relationship with others, especially where two individuals are not very familiar with each other. Commonalities also help to avoid missteps by helping individuals to avoid topics of conversation where conflicts might arise. For example, a common interest in politics might be a point of conversation unless each individual is a partisan on opposite sides of a debate. Automated determinations of commonalities help to make social networking a more useful tool for end users, both in personal and business settings.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 depicts a block diagram of a server supporting commonality requests from clients based upon commonalities found in social networking information of a sender and recipient of a message possessing an icon; and

FIG. 2 depicts a flow diagram of a process for supporting commonality requests from a client computer system based upon commonalities found in social networking information of a sender and recipient of a message having a commonality message;

FIG. 3 depicts a flow diagram of a process for tracking commonality reports issued in response to activation of a icon at a message; and

FIG. 4 depicts a flow diagram of a process for initiating a comparison by an account independent of a message.

FIG. 5 depicts a block diagram of an icon manager for managing the content aggregation, curation, sharing, analyzing and presentation from one's multiple social media and contact points across multiple forms of communication.

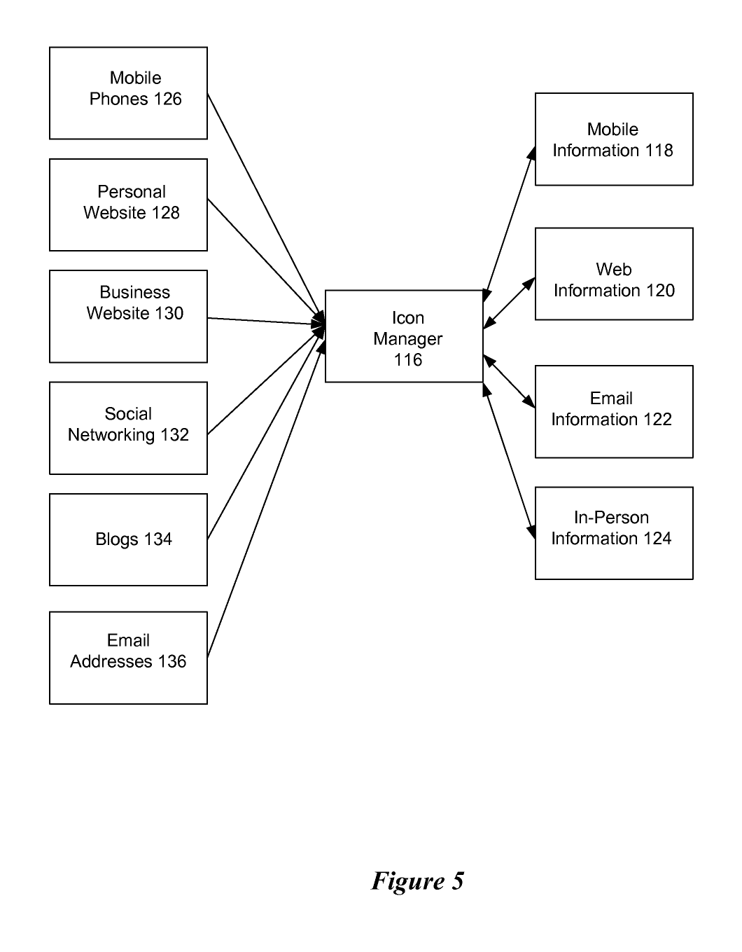

### DETAILED DESCRIPTION

Social networking, such as is available from Facebook, Twitter, Linked-in and other social networking network locations, has created a vast wealth of information regarding personal preferences of a large number of social networking users. Social networking end users post and read information that indicates their income, education, social status, political leanings, employment, volunteer positions, etc. . . . Although access to social networking information for particular end users is typically limited based upon a relationship with a particular end user, an open secret among social networking users is that social networking websites gather and use social networking information to target advertising at end users. Generally, end users accept some limited risk to their privacy as a price to pay for access too social networking resources.

Varying layers of limitations to access of social networking information have made social networking websites of limited use to end users who want to learn about other end users. Generally, for instance, if a salesperson intends to make a sales pitch to a potential customer, the salesperson wants to learn about the potential customer to increase the odds of a successful sales pitch. Although the potential customer may have frequent interactions with social networking websites, the salesperson likely will have only limited if any access to the potential customer's social networking information. For instance, the salesperson cannot access all of the information on the potential customer's LinkedIn page without having a relationship through LinkedIn with the potential customer. Similarly, the salesperson cannot access Facebook postings unless the salesperson becomes a friend of the potential customer. Often, once a relationship is initiated on a social networking website, it remains in place unless terminated by one member of the relationship. Termination of a social networking relationship is often uncomfortable for both parties to the relationship so that social networking users tend to avoid establishing temporary types of social networking relationships.

The present invention provides social networking users with a tool for using social networking information that does not interfere with social networking website use. A server receives social networking information for each of plural social networking users and compares the social networking information to find commonalities between social networking users. For example, an icon message shared through email, web or sms communication to a recipient prompts activation and analysis. In order to send the message with the icon, the sender has to provide social networking information of the sender to the server. Upon activation of the icon by a recipient of the message, the recipient's computer interfaces with social networking network locations of the recipient to retrieve social network information that is in turn forwarded to the server for use by a commonality engine executing from memory of the server. The commonality engine analyzes sender and recipient social networking information to determine commonalities for presentation to the recipient without having to establish an actual relationship on the social network between the sender and recipient. Although the recipient is provided with commonalities to the sender, the recipient does not himself have to have access to the sender's social networking information so that a degree of privacy is maintained.

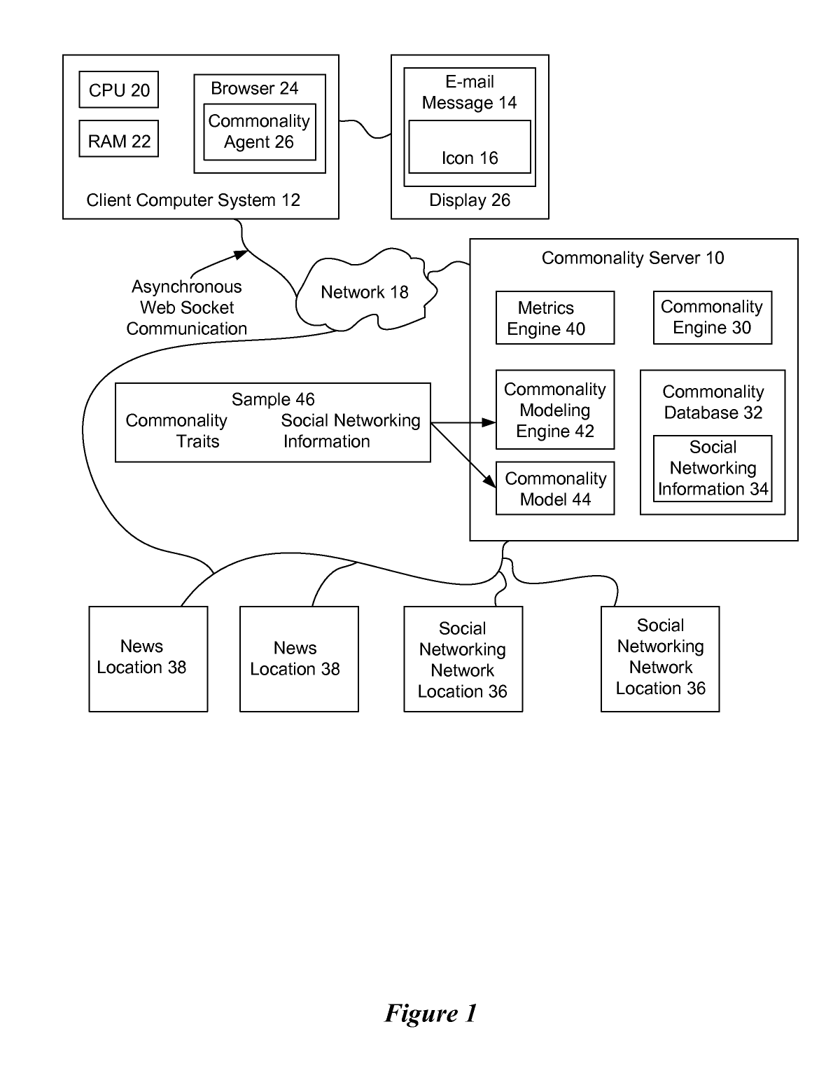

Referring now to FIG. 1, a block diagram depicts a commonality server 10 supporting commonality requests from clients 12 based upon commonalities found in social networking information of a sender and recipient of a message 14 having a icon 16. Server 10 interfaces with client computer systems 12 through a network 18, such as the Internet. Client computer systems 12 process information with a processor, such as a CPU 20, interfaced with a memory, such as RAM 22, to support execution of instructions for running an application, such as a Web browser 24. Other computer systems referenced herein, such as server 10, use a similar processor and memory architecture to execute instructions in a variety of computer languages, such as C++, and communicate in a variety of network protocols, such as TCP/IP. For example, client computer systems 12 may be desktop, laptop, tablet, smartphone or other types of computing platforms that execute instructions of a variety of applications as in known in the art. A display 26 interfaced with processor 20 and memory 22 presents information as visual images perceptible to an end user, such as e-mail 14 presented with a signature of its sender having icon 16.

When an end user of a client computer system 12 presents message 14 at display 26 that includes an icon 16, then the end user can activate the icon 16 by clicking on it with a mouse cursor. In alternative embodiments, icon 16 may be presented in a variety of different types of messages, such as social networking posts, or outside of messages, such as at the end of an article written by an end user associated with the icon. In the example embodiment, icon 16 includes the name and contact information of the end user who sent message 14 and a picture of the sender, such as with an electronic business card. Embedded within icon 16 is an identifier of the sender that browser 24 can provide through network 18 to server 10. In one embodiment, icon 16 embeds an identifier of the type of social networking information that is available for the sender at server 10 to perform a commonality analysis, such as the identity of social networking network locations that provided social network information of the sender (e.g., Twitter, Facebook, LinkedIn, etc. . . . ).

Upon activation of icon 16 by the end user of client computer system 12, a commonality agent 28 executing in cooperation with browser 24 initiates contact with server 10 through network 18 to request a commonality report of commonalities between the sender of message 14 and the end user recipient of message 14. At server 10, a commonality engine 30 performs the commonality analysis and provides commonalities determined by the commonality analysis through network 18 to commonality agent 28 for presentation at display 26. The basis for the commonality analysis depends upon the type of social networking information available for the sender and recipient of message 14. Commonality engine 30 checks in a commonality database 32 to locate social networking information of the sender of message 14 based upon the identifier of icon 16 provided from commonality agent 28. Generally, in order to have an account that allows the use of an icon 16, the sender of message 14 will have provided social networking information 34 for storage in commonality database 32. Commonality engine 30 also checks to see if the recipient of message 14 who has requested the commonality report has social networking information 34 stored in commonality database 32. If the recipient has social networking information 34 stored in commonality database 32, then commonality engine 30 performs the commonality analysis and set forth below and provides the commonality report to commonality agent 28 for presentation. If the recipient end user of client computer system 12 does not have social networking information 34 in commonality database 32, then commonality engine 30 requests retrieval of social networking information of the recipient from commonality agent 28.

In one embodiment, commonality agent 28 responds to a request for social networking information from commonality engine 30 by requesting that the end user recipient approve download of social networking information from social networking network locations 36 to client computer system 12. Once social networking information for the recipient end user is retrieved to client computer system 12, commonality agent 28 forwards the social networking information through network 18 to server 10 for storage in commonality database 32 and use in a commonality analysis by commonality engine 30. For example, the recipient end user is requested to establish an account as a condition of access to the commonality analysis. As part of the account initiation, the end user recipient provides social networking access information to commonality agent 28, via authentication mechanisms such as OAuth defined by the social networking network locations 36. Commonality agent 28 retains the revocable authentication tokens to periodically update social networking information of the end user; however, the tokens remain confidential to the end user at client computer system 12. In an alternative embodiment, to speed up the download of social networking information, downloads may be performed from server 10 by providing account authentication information to server 10. Some examples of social networking information include: a Twitter handle and authentication token that retrieves tweets received and or sent by the end user; a Facebook identifier and authentication token that retrieves the end user's Facebook page and posts received and made by the end user; a LinkedIn identifier and authentication token that retrieves a LinkedIn page and communications; etc. . . .

In alternative embodiments, commonality engine 28 responds to a request for social networking information from commonality engine 30 by social networking information from social networking network locations 36 in alternative manners. For example, some social networking information is available without approval from social networking end users. For instance, Twitter social networking information is available with a username and may be retrieved via an unauthenticated API call. Thus, a commonality determination may be available to an end user without obtaining an account for access to the commonality engine. Alternatively, comparisons may be restricted to end users who have accounts even where social networking information is publicly available. Where both end users have an account, stored social networking information may be used for one of the end users. Also, social networking information for a new end user who has established a new account will be acquired as a function of establishing the account rather than in response to a commonality search request.

Commonality engine 30 applies social networking information 34 for the sender and recipient to determine commonalities between the sender and recipient. For instance, commonality engine 30 is a natural language analyzer that extracts semantic meta-data, such as information about people, places, companies, topics, facts and relationships, authors, languages, etc. . . . , for the social networking information of the sender and recipient. One example of a commonality engine 30 is AlchemyAPI available at Alchemyapi.com. In an example embodiment that uses Alchemyapi.com, commonality engine is distributed between separate locations so that text processing is performed separately from a commonality analysis. In various embodiments, various types of social networking information may be selectively applied to determine commonalities. In one embodiment, commonality analysis focuses on the social networking page of the sender and recipient, such as a comparison of Facebook home pages, LinkedIn home pages, or Tweets made from a Twitter handle. In an alternative embodiment, commonality analysis focuses in on aspects of social networking information that tends to highlight interests of an end user. For example, Tweets are filtered to detect URL links to news locations 38 that identify a news story received by or sent by the twitter handle. Commonality engine 30 retrieves the content from the news location 38 with the URL link and uses the content as part of the commonality analysis. In an alternative embodiment, commonality engine 30 performs commonality analysis only on content from URL links re-tweeted by an end user since a re-tweet tends to indicate a higher interest in the content. An alternative embodiment may use tweets and retweets, and links other than news stories, such as links to blog posts, pictures, or any other retrievable information. Alternative embodiments use alternative types of social networking information, such as “likes” made to news stories, products, posts, etc. . . . from a Facebook account of an end user. The commonalities reported by commonality engine 30 might include a common interest in a music genre, a music band, a technical or scientific topic, a volunteer activity, a non-profit group, a political party or candidate, etc. . . . The commonality may be further defined to focus on specifics within a topic, such as common interest in politics where the sender and recipient prefer opposite sides of the political spectrum. Commonalities provided by commonality engine 30 guide the recipient towards a better understanding of how to approach and how not to approach the sender.

A metrics engine 40 running on server 10 tracks commonality report requests made to commonality engine 30 to provide metrics to senders of messages 14. In one embodiment, metrics engine 40 sends a duplicate copy of the commonality report provided to a message recipient to the message sender so that the message sender is prepared to engage with the recipient on an even playing field. As an alternative, metrics engine 40 tracks requests for commonality reports so that end users can see who has viewed a message 14 and who has activated icon 16. For instance, if a message 14 is an e-mail forwarded to multiple end users, the sender can see how the e-mail has been communicated. In one embodiment, each icon 16 includes a unique identifier to track the message 14 to which it belonged so that metrics engine 40 provides the end user with an ability to retrieve the message 14 that resulted in a commonality request.

In one embodiment, a commonality modeling engine 42 generates commonality models 44 that relate commonality traits to social networking information using various statistical methods, such as regression or neural networks. For instance, a sample population 46 is gathered in which commonality traits are known, such with a poll or questionnaire. The sample population has social networking information downloaded from social networking network locations 36 so that commonality models 44 are built that define relationships between commonality traits and social networking information. Commonality models 44 aid in the definition of commonalities by predicting commonality traits of a sender and recipient from the social networking information of the sender and recipient, and comparing the predicted commonality traits to identify commonality traits shared by the sender and recipient. Commonality models 44 aid in providing commonalities where social networking information is limited in quality or quantity and where available social networking information for a sender and receiver comes from different social networking sources.

In some instances, determining commonalities may take a fair amount of time as social networking information is downloaded to server 10, analyzed and commonality reports are forwarded to client computer system 12. In one embodiment, browser 24 establishes an asynchronous communication with server 10 so that results are forwarded to client 12 as the results become available. For example, a websocket provides asynchronous communication so that commonality reports for each of plural social networking network locations can be presented at client 12 as the commonality reports issue from commonality engine 30. If icon 16 indicates one or more social networking network locations 36 used by a sender of message 14, then commonality agent 28 provides more rapid results by first initiating retrieval of social networking information from those locations for the recipient before retrieving social networking information from other locations.

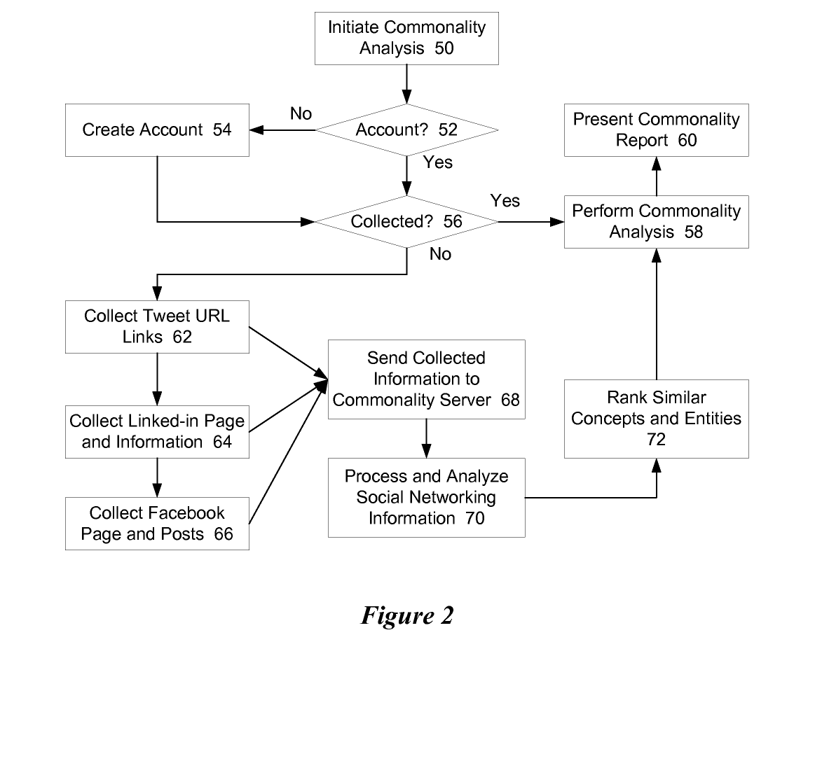

Referring now to FIG. 2, a flow diagram depicts a process for supporting commonality requests from a client computer system based upon commonalities found in social networking information of a sender and recipient of a message having a commonality message. The process begins at step 50 with activation of an icon by an end user recipient of a message, which initiates contact with a commonality server. At step 52, a determination is made at the commonality server of whether the recipient has an account. If not, the process continues to step 54 to initiate an account for the recipient. In one alternative embodiment, an account is not required although the commonality analysis is restricted to publicly available information, such as Twitter information. If the recipient has an account or after an account is set up at step 54, the process continues to step 56 to determine if a collection of social networking information has been done for the recipient and is available in a commonality database. Although the present embodiment envisions an account as a prerequisite for a commonality report, in alternative embodiments, access may be offered to recipients that lack an account, such as for a limited number of commonality reports. If at step 56, the recipient has social networking information in the commonality database, the process continues to step 58 to retrieve social networking information for the sender and recipient and perform a commonality analysis to determine what the sender and recipient have in common. At step 60, a commonality report issues with commonalities between the sender and recipient indicating what the sender and recipient have in common, such as Mexican food, sports cars, rose gardening, etc. . . .

If at step 56 social networking information is not found for the recipient, the process continues to step 62 to initiate a search for social networking information on Twitter using the recipient's Twitter handle. For example, the browser on the recipient's client computer system collects the last 200 Tweets and finds the ten most recent links tweeted or re-tweeted by the user, such as with a Javascript running with the browser. In one alternative embodiment, tweets and re-tweets are gathered by the commonality server instead of the user's browser. At step 64, the browser collects information available from a LinkedIn account of the recipient. In one embodiment, LinkedIn data is loaded with server communication using a revocable token authorized by an end user. At step 66, the browser collects information available from a Facebook account of the recipient. The type of information retrieved from LinkedIn and Facebook may be focused to that social networking information most useful for a commonality analysis, such as likes or posts of the recipient relating to news articles. As the recipient's browser collects social networking information at steps 62, 64 and 66, the information is forward so that at step 68 relevant social networking information for performing a commonality analysis is extracted. At step 70, the social networking information of the sender and recipient are analyzed to determine commonalities. At step 72, similar concepts and entities found in the sender and recipient social networking information are ranked. At step 60, the commonality information is presented to the recipient.

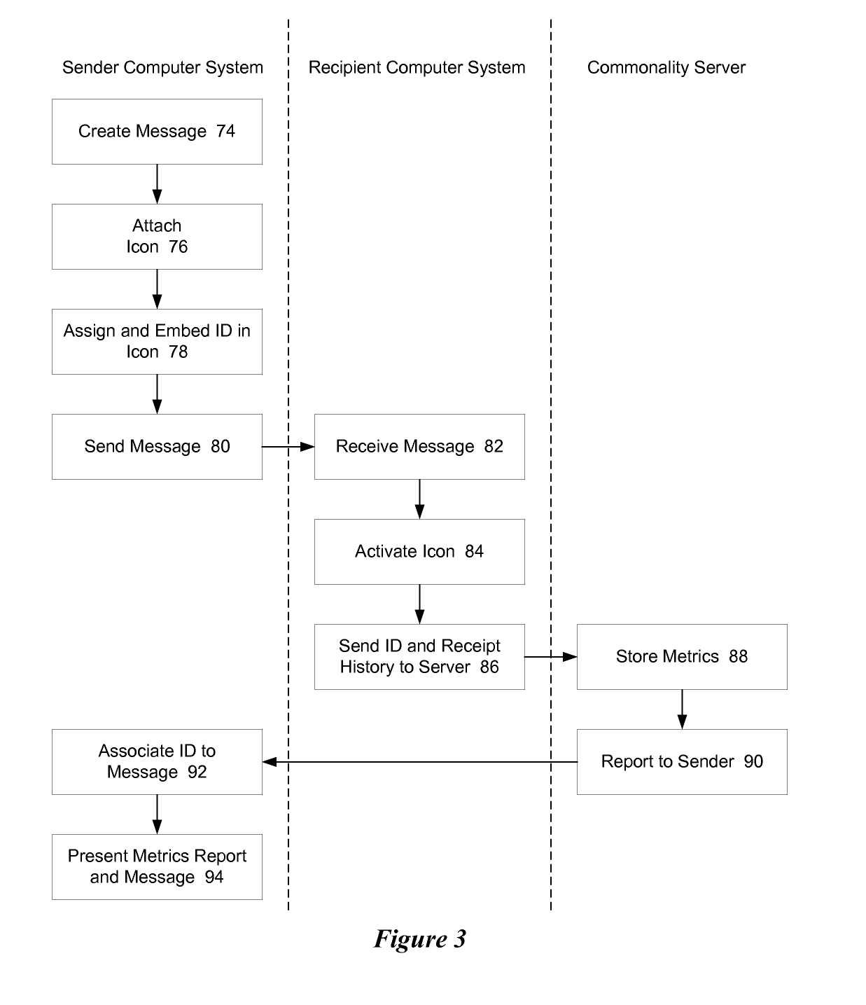

Referring now to FIG. 3, a flow diagram depicts a process for tracking commonality reports issued in response to activation of an icon at a message. The process begins at step 74 with the creation of a message by a sender at a client computer system, such as an e-mail, a social networking post, a blog, a blog post or other types of messages. At step 76, the sender attaches an icon associated with the sender to the messages, such as in a signature at the end of an e-mail. At step 78, an identifier associated with an icon is generated when the end user generates the icon and copies the icon to an email signature so that no additional tagging of the icon is required from an email client. Alternatively, logic associated with the icon assigns an identifier to the message and embeds the identifier in the icon, such as with a Javascript running as a plug-in to a browser or e-mail program. At step 80, the sender sends the message, such as by sending an e-mail from the sender's computer system to an e-mail server. Upon sending the message, the sending computer system may, via Javascript running as a plug-in to a browser or e-mail program, report the message and unique identifier to a commonality server or reporting may await activation of the icon by a recipient at a recipient computer system.

At step 82, the message is received at a recipient computer system and presented at a display, including presentation of the icon. At step 84, the icon is activated at the recipient computer system, such as by selection of the icon with a mouse by a recipient at the recipient computer system to execute an application, such as a web browser. In one alternative embodiment, activation may include a passive activation when the icon automatically contacts a commonality server to retrieve information for presentation. At step 86, upon activation logic associated with a Javascript plug-in may send the embedded identifier and a history of recipients of the message to a commonality server. For example, an application executes upon activation of the icon as an email client plugin and reads the history of the message to determine how the message was received and forwarded by recipients.

At step 88, the commonality server receives and stores the icon identifier and receipt history from the recipient computer system, and stores the information in a metrics database. At step 90, in response to receipt of the icon and receipt history, the commonality server generates a metrics report that includes the icon identifier and forward the metrics report to the message sender. Alternatively, the commonality server stores the metrics information until a message sender requests a metrics report.

At step 92, the sender computer system receives the metrics report and associates the icon identifier with the message sent by the sender. In one alternative embodiment, the commonality server may coordinate e-mail communications with an e-mail server so that the e-mail server sends the metric report along with the message associated with the icon identifier, such as by a plugin application. At step 94, the metrics report is presented at the sender computer system along with the original message so that the sender can track who received the message, who forwarded the message, and who in the message chain viewed the icon.

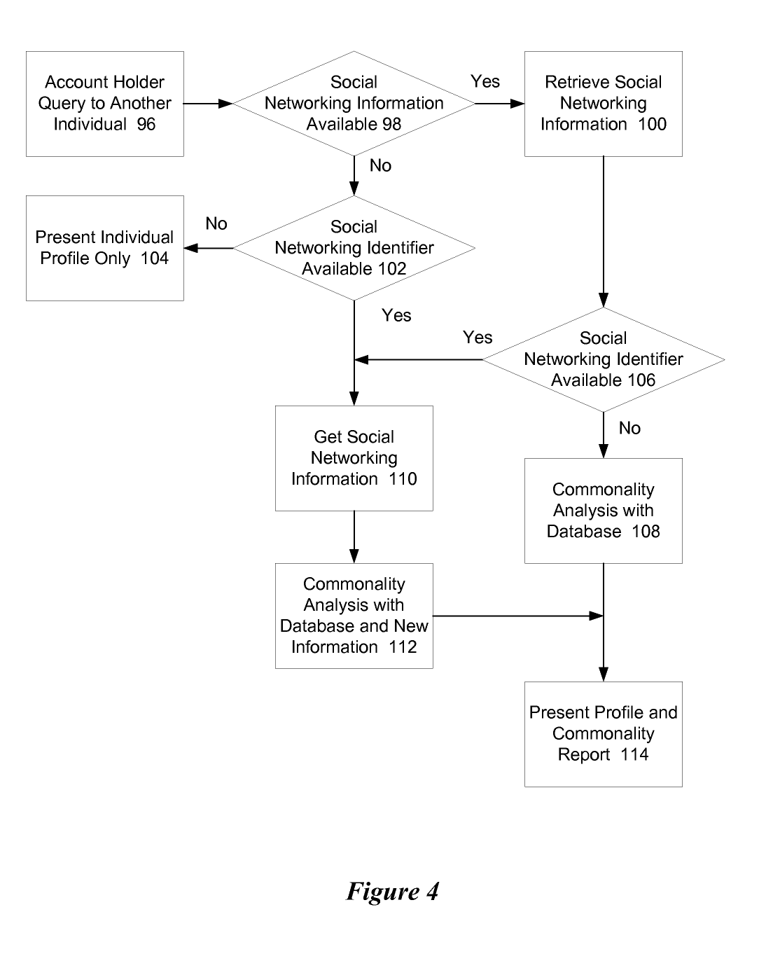

Referring now to FIG. 4, a flow diagram depicts a process for initiating a commonality comparison by an account independent of a message. At step 96, an account holder signs into the commonality server and states a query for commonalities with another individual, whether or not another account holder. In one alternative embodiment, non-account holders may be provided with access to commonality searches, such as with limits on the type of information used to analyze commonality; for instance, a twitter search may provide commonality based on publicly available tweets. At step 98, a determination is made of whether the individual subject of the query has social networking information available on the commonality server, such as would likely be the case if the query relates to another account holder. If the determination is yes, the process continues to step 100 to retrieve the social networking information related to the query. If the determination at step 98 is no, the process continues to step 102 to determine if social networking information is available. For example, at step 102 the account holder stating the query can input the Twitter name of the subject of the query to allow the account holder's computer system to retrieve the social networking information of the subject of the query. If no additional social networking information is available at step 102, then a commonality analysis is not performed and the process ends at step 104 by presenting a profile in response to the query that includes any available information.

At step 100, after retrieval of available social networking information from the commonality server, a determination is made at step 106 similar to that at step 102 as to whether additional social networking information is available relating to the subject of the query. If no additional social networking information is available at step 106, the process ends at step 108 with a commonality analysis based upon social networking information stored on the commonality server. If at step 102 or step 106 a determination is made that additional social networking information is available, the process continues to step 110 to get the additional social networking information. At step 112, a commonality analysis is performed with all available social networking information and, at step 114, a report for the commonality analysis is provided to the account holder.

An end user representation as an icon provides access to commonality analysis, however, related capabilities allow the icon to become an end user's control of online brand management for professional and personal use. An icon included with an electronic message or other stored information available through a network acts as a digital business card that curates content, shares relevant information in a managed way, provides commonality as a tool for nurturing relationships, and supports personal brand analytics. An icon manager 116, such as an application executing on a server and accessible as a user interface presented at a display, provides a centralized tool for an end user to manage an online brand with control over mobile phone information 118, network information 120, email information 122 and physical or in-person information 124, such as physical business cards with a QR code that points a recipient of the physical card to a network location that interacts with icon manager 116. Icon manager 116 curates a professional and/or personal persona by aggregating relevant content from an icon's social networking feeds, such as LinkedIn, Facebook and Twitter feeds. Icon manager 116 curates filters and adds value to social networking content so that an icon end user can monitor, research and investigate how others perceive the icon end user's online brand. The icon end user can market and advance the online brand through icon manager 116 by sharing the brand with an icon in virtually any situation. Icon use and communication is readily tracked as others interact with icons to provide powerful insights on who is viewing, saving and sharing an icon user's information. Commonality information based upon social networking provides a practical tool that allows an icon end user to gain valuable insights for nurturing relationships from what can otherwise be a confusing array of social networking information.

Icon manager 116 interacts with an end user's mobile telephone 126 in a number of ways to track and manage mobile phone information 118. For instance, an icon presents as a visual image at a display of the mobile telephone 126 for visual inspection by individuals as a representation of a business card. The icon transfers to other mobile phones with plural various techniques, such as by a near field communication to another's list of contacts or as a file transferred through a network so that an individual viewing the icon image obtains contact information of the icon user, such as phone, email or regular mailing information. At transfer of an icon, a unique identifier associated with the icon is reported to icon manager 116 to report on usage of the icon associated with the transfer, such as subsequent transfers or subsequent usage to initiate a communication. If an individual who receives the icon is an initial contact, icon manager 116 can automatically initiate a commonality analysis and report commonalities to the icon's associated user and to the recipient if the recipient has an icon commonality account. In addition, mobile phone 126 supports email and text messaging communication with an icon that provides reference back to the icon transfer event at the mobile phone in addition to functionality supported by the specific type of transfer, such as commonality functionality discussed above.

Icon manager 116 curates a variety of web information 120 to allow an icon end user to manage a web brand that presents a desired image. For example, icon manager 116 captures web information 120 for personal websites 128, business websites 130, social networking websites 132, blogs 134 and other types of web resources for access through a personal and/or business web page. Centralized web information 118 advantageously offers icon recipients a resource managed by an icon user with links to web information that is otherwise disjointed and difficult to organize. The icon web page provides a professional overview with curated social links that allow the icon user to manage the online brand that the icon user wishes to present. Rather than risking search engine results that may or may not provide desired and even accurate information, the icon end user has curated social links, a vCard download and contact information that points interested individuals to relevant web information. An icon user can attach icons to electronic materials presented on the web, such as blog posts, to provide a compact and accurate brand presentation rather than having to repeatedly include such information on the web. The icon remains up-to-date with the brand image desired by the end user no matter how dated the web information may become.

Icon manager 116 aggregates email information 122 for email accounts 136 to provide all contact information in one interactive email signature. A custom and interactive email signature is fully brandable to adapt to an icon end user's branding preferences. Unique identifiers associated with icons that are included in email messages are aggregated by icon manager 116 so that email communications from multiple accounts may be analyzed in aggregation. As an example, links communicated by email with an icon user are included in commonality analysis so that commonality across business and personal email accounts for a given user may be included with commonality extracted from links in social networking information. An end user who forwards a news story link in a personal email account has the news story associated with social networking links based upon a relationship established with icon unique identifiers to provide a more complete commonality analysis.

Icon manager 116 also ties in person information 124 with digital information by tracking the use of an icon in physical form. For example, a QR code presented on a business card or an NFC enabled business card provides a URL to an icon with a unique identifier tied to the business card. When the recipient of the business card references the icon with the URL and unique identifier, analytics about the use are tracked by icon manager 116 and related to digital information, such as email, web and mobile information.

Analytics provided by icon manager 116 across mobile information 118, web information 120, email information 122 and in person information 124 provide insights into impressions that recipients have to an icon user's brand, responses to the icon, shares and/or saves of the icon, geographical breakdowns of icon interfaces and commonalities. For example, activation of an icon from any source is tracked by source so that an icon user can see how a particular icon was received by an audience. For instance, an icon included with a sales presentation is tracked to show the timing and quantity of icon interactions that lead to a product sale. If a sale results from a saved icon, the original distribution of the icon may be tracked by a unique identifier. Commonality requests are tracked by requester and include results, such as the types and frequency of commonalities that are identified, the topics in common and communications that originate from an icon from which a commonality analysis was requested. When commonalities are found, icon users will typically experience increase response rates, higher conversion rates, more relevant relationship building communications, ongoing relevant relationships and lasting relationships.

Although the present invention has been described in detail, it should be understood that various changes, substitutions and alterations can be made hereto without departing from the spirit and scope of the invention as defined by the appended claims.

What is claimed is:

1. A method for relating social networking end users by commonality through a digital business card, the method comprising:
sending a message from a first user through a network to a second user, the message having a icon associated with the first user;
activating the icon at the second user;
in response to activating, comparing social networking information of the first user and second user to find one or more commonalities between the first user and second user; and
presenting the one or more commonalities to the second user.

2. The method of claim 1 wherein the social networking information comprises network address links posted by at least one of the first and second users, the method further comprising:
retrieving content from the network address links; and
analyzing the content to determine one or more commonality factors.

3. The method of claim 1 further comprising:
obtaining social networking information related to the second end user by retrieving the social networking information with a browser of the second user; and
forwarding the social networking information from the browser of the second user through a network to a server having logic to perform the comparing.

4. The method of claim 3 further comprising:
establishing asynchronous communication between the browser of the second end user and the server; and
communicating the one or more commonalities to the browser of the second end user as the server determines the one or more commonalities.

5. The method of claim 4 wherein the asynchronous communication occurs over a websocket.

6. The method of claim 1 wherein the social networking information comprises content retrieved from network address links re-tweeted by the second end user.

7. The method of claim 1 wherein the social networking information comprises content retrieved from network addresses associated with a Facebook like indication by the second end user.

8. The method of claim 1 further comprising:
generating a model of commonalities in a sample population using commonality traits and social networking information of the sample population; and
applying the model to social networking information of the first and second users to determine one or more modeled commonalities between the first and second users.

9. The method of claim 1 wherein the message comprises an e-mail and the icon comprises an electronic business card of the first end user included in the e-mail.

10. A system for relating social networking end users by commonality, the system comprising:
a commonality engine stored in memory of a server interfaced with a network, the commonality engine operable to compare social networking information of first and second users to determine one or more commonalities of the first and second users; and
a client associated with the second end user, the client interfaced with the server through the network and having a display operable to present messages, at least one of the messages having a icon associated with the first end user, the icon operable upon activation by the second end user to request through the network one or more commonalities between the first and second end users from the commonality engine;
wherein, in response to the request, the commonality engine compares social network information of the first and second end users to determine one or more commonalities of the first and second end users and communicates the one or more commonalities to the client through the network.

11. The system of claim 10 further comprising:
a commonality agent stored in memory of the client and operable to interface with one or more social networking network locations to retrieve social network information of the second end user; and
a commonality database associated with the server and storing social information of the first end user;
wherein the commonality agent stores the social network information of the second end user in the database for access by the commonality engine.

12. The system of claim 10 wherein the message comprises an e-mail from the first end user having the icon presented as a signature of the first end user.

13. The system of claim 10 wherein the message comprises a social networking network location post made by the first end user.

14. The system of claim 10 further comprising:
a commonality modeling engine associated with the server and operable to generate one or more commonality models based upon a sample population having commonality traits and social networking information of the sample population; and
at least one commonality model generated by the commonality engine, the commonality model operable to apply social networking information of the first and second end users to determine one or more modeled commonalities between the first and second users.

15. The system of claim 10 wherein the social networking information comprises network address links to news stories sent by the second end user through a social networking network location, the commonality engine further operable to retrieve the news stories for comparison with news stories sent by the first end user through the social networking network location.

16. The system of claim 10 wherein the social networking information comprises network address links tweeted or re-tweeted by the second end user, the commonality engine further operable to retrieve the contents of the network address links for comparison with social networking information of the first end user.

17. The system of claim 10 further comprising a metrics engine stored in memory of the server and operable to track comparisons done by the comparison engine for presentation to the first end user.

18. A computer system comprising:
a processor operable to execute instructions;
memory interfaced with the processor and operable to store instructions; and
a commonality agent stored in the memory and having instructions that run on the processor to:
initiate communication through a network with one or more social networking network locations associated with an end user;
retrieve social networking information through the network from the social networking network locations to the memory;
forward the social networking information through the network to a commonality database associated with a commonality engine, the commonality engine operable to compare the social networking information with a different end user; and
retrieve one or more commonalities from the commonality engine for presentation to the end user.

19. The computer system of claim 18 further comprising:
a display interfaced with the processor and operable to present information as visual images; and
a icon of the different end user presented at the display and operable to accept activation by the end user, the activation providing for execution of the initiate communication instruction.

20. The computer system of claim 19 wherein the icon comprises a signature of the different end user presented at the display with an e-mail message of the different end user.
